(19) United States
(12) Patent Application Publication
(10) Pub. No.: US 2009/0226683 A1
(43) Pub. Date: Sep. 10, 2009

(54) Porous Material Uses in Furniture

(76) Inventors: Bernard Perry, Erie, CO (US); Ray L. Hauser, Boulder, CO (US); Kirby Beard, Norristown, PA (US)

Correspondence Address: Porous Power Technologies-Correspondence, Krajec Patent Offices, LLC, 820 Welch Ave, Berthoud, CO, 80513, US

(21) Appl. No.: 12/398,461

(22) Filed: Mar. 5, 2009

Related U.S. Application Data
(60) Provisional application No. 61/034,136, filed on Mar. 5, 2008.

(51) Int. Cl. B68G 11/04; B32B 3/26; B32B 27/18; B05D 5/00

(52) U.S. Cl. 428/198; 428/315.5; 428/305.5; 427/246

(57) ABSTRACT

A microporous fire resistant film coated or laminated composite textile may be uses as an upholstery fabric or mattress ticking which provides an air permeable microporous barrier to liquid, allergen or pathogen particle, or biological organism penetration. The microporous cellular structure of the coated or laminated film backing may provide a high capacity reservoir which may contain additives such as antimicrobial, UV absorbing, scent dispersing, or organism repelling particles or other functional agents, while maintaining superior barrier and air permeability properties in the finished product constructions. Applications may include any seating and bedding products where a combination of two or more of the above properties is desired.

### BACKGROUND

Comfortable furniture materials often have high air permeability. The ability to ‘breathe’ allows heat and perspiration to be removed from a person, enhancing the person's comfort. However, various materials and organisms that pass through conventional furniture coverings may cause discomfort to a user as well as problems to the underlying furniture structure.

### SUMMARY

A microporous fire resistant film coated or laminated composite textile may be uses as an upholstery fabric or mattress ticking which provides an air permeable microporous barrier to liquid, allergen or pathogen particle, or biological organism penetration. The microporous cellular structure of the coated or laminated film backing may provide a high capacity reservoir which may contain additives such as antimicrobial, UV absorbing, scent dispersing, or organism repelling particles or other functional agents, while maintaining superior barrier and air permeability properties in the finished product constructions. Applications may include any seating and bedding products where a combination of two or more of the above properties is desired.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a cross-section of reinforced porous material.

FIG. 2 is a flowchart illustration of an embodiment showing a method for forming a porous material.

FIG. 3 is a diagram illustration of an embodiment showing a process for continuous manufacturing of reinforced porous material.

FIG. 4 is a diagram illustration of an embodiment showing a process for a dip method of continuous manufacturing of reinforced porous material.

FIG. 5 is a diagram illustration of an embodiment showing a one-sided laminating method for manufacturing a reinforced porous film.

FIG. 6 is a diagram illustration of an embodiment showing a two-sided laminating method for manufacturing a reinforced porous film.

FIG. 7 is a flowchart illustration of an embodiment showing a method for forming a porous material with loading materials.

FIG. 8 is a diagram illustration of an embodiment showing an article of upholstered furniture.

FIG. 9 is a diagram illustration of an embodiment showing a cross section view of an upholstered mattress.

FIG. 10 is a diagram illustration of an embodiment showing a cross sectional view of an upholstered item.

### DETAILED DESCRIPTION

A reinforced porous film may be constructed through various processes and using various formulations to be used in different applications for bedding components. The film may have a pore structure that may enable high amounts of airflow, but where the pores may be infused with various antimicrobial, UV absorbing, scent dispersing, and organism repelling materials.

In some applications, the porous film may be loaded with various materials that may actively or passively prevent or inhibit fungal or bacterial growth, repel insects, or otherwise prevent microbes or pests from passing through. Some applications may include materials that may absorb environmental pathogens. Such materials may be included in the porous film by including the materials during the formation of the porous material or after the porous material has been formed.

Applications for such film may be for seating areas of various furniture applications.

A reinforced porous film may be created by several methods. Porous films by nature may be structurally weak, especially films with high porosity. A reinforced film may be considerably more structurally sound than an unreinforced film. Increased mechanical properties may help during handling and manufacturing of the film into various products, as well as increased structural properties of an end product.

One method for producing a reinforced porous film may be to create the porous material with a reinforcement. For example, a solution used to create the porous material may be cast or sprayed onto the reinforcement. In another example, the reinforcement may be dipped into the solution.

Another method for producing a reinforced porous film may be to form a porous film and subsequently bond the porous film to a reinforcement. The bonding may be accomplished using mechanical interlocking, heat fusing, adhesives, or any other mechanism.

The reinforcement may be any type of woven or nonwoven material, perforated film, or any other web material. For the purposes of this specification, any references to any type of reinforcing web shall be interpreted to mean any type of reinforcing web, including nonwoven and woven reinforcement.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

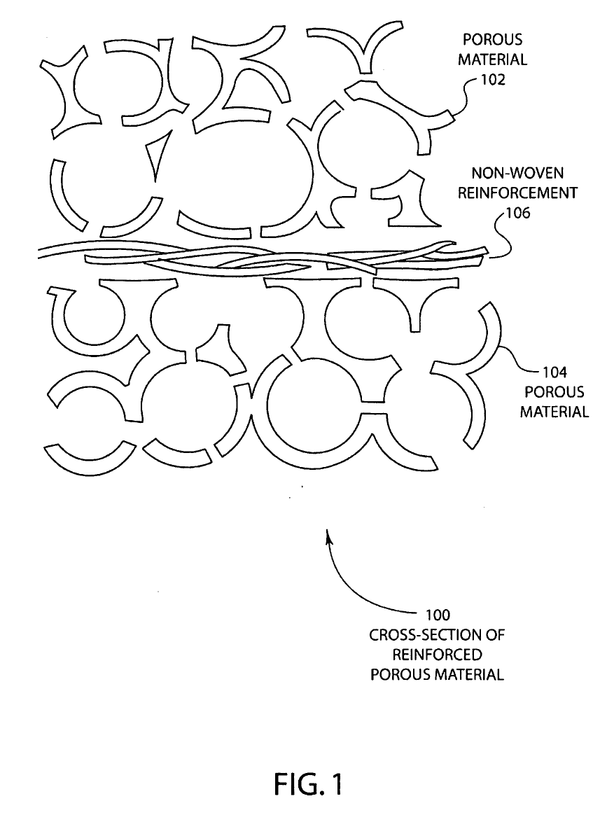

FIG. 1 is a schematic diagram of an embodiment 100 showing a cross section of porous material that may be formed using a solution of a polymer dissolved in a solvent and a miscible pore forming agent that has a higher surface energy. The porous material 102 and 104 is shown on both sides of a web 106.

FIG. 1 is not to scale and is a schematic diagram. In some embodiments, the porous material 102 and 104 may impregnate the non-woven web 106. Such embodiments may have partial impregnation or complete impregnation of porous material 102 and 104 into the thickness of the non-woven web 106. Some embodiments may have mechanical or chemical adhesion of the porous material 102 and 104 to the surface of the non-woven web 106. Other embodiments may vary in cross section based on the specific manufacturing process used and may have full impregnation or very little mechanical interlocking between the layers.

Embodiment 100 may be manufactured by several different methods. In some cases, the porous material 102 and 104 may be formed separately and bonded to the non-woven reinforcement 106. In other cases, the porous material 102 and 104 may be formed from a solution that may be applied to the reinforcement 106 in a liquid form and processed to yield the porous material 102 and 104 with the reinforcement 106.

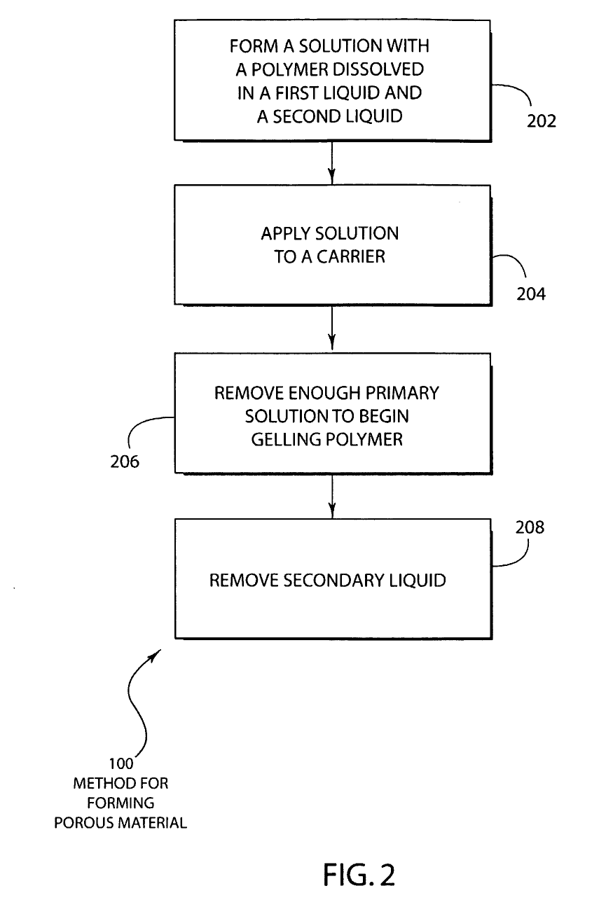

FIG. 2 is a flowchart diagram of an embodiment 200 showing a method for forming a porous material. Embodiment 200 is a general method, examples of which are discussed below.

In block 202, a solution may be formed with a polymer dissolved in a first liquid and a second liquid that may act as a pore forming agent. The liquids may be selected based on boiling points or volatility and surface tension so that when processed, the polymer is formed with a high porosity. Examples of such liquids are discussed below.

After forming the solution in block 202, the solution is applied to a carrier in block 204. The carrier may be any type of material. In some cases, a flat sheet of porous material may be cast onto a table top, which acts as a carrier in a batch process. In other cases, a film such as a polymer film, treated or untreated kraft paper, aluminum foil, or other backing or carrier material may be used in a continuous process. In such cases, a porous film may be manufactured and attached to a reinforcing web in a secondary process. In still other cases, the carrier material may be a nonwoven, woven, perforated, or other reinforcing web. In such cases, the solution may be applied by dipping, spraying, casting, extruding, pouring, spreading, or any other method of applying the solution.

The reinforcing web may be any type of reinforcement, including polymer based nonwoven webs, paper products, and fiberglass. In some cases, a woven material may be used with natural or manmade fibers, while in other cases, a solid film may be perforated, slotted, or expanded and used as a reinforcing web.

In block 206, enough of the primary liquid may be removed so that the dissolved polymer may begin to gel. In some embodiments, some, most, or substantially all of the primary liquid may be removed in block 206. As the polymer begins to gel, the mechanical structure of the material may begin to take shape and the porosity may begin to form. During this time, the material may have some mechanical properties so that different mechanisms may be used to remove any remaining primary liquid and the secondary liquid.

The secondary liquid may be removed in block 208. During the gelling process of block 206, the differences in surface tension between the various materials may allow the secondary liquid to coalesce and form droplets, around which the polymer may gel as the first liquid is removed. After or as the polymer solidifies, the second liquid may be removed. In some cases, the boiling point or volatility of the two liquids may be selected so that the primary liquid evaporates prior to the secondary liquid.

The mechanisms for removing the primary and secondary liquids may be any type of suitable mechanism for removing a liquid. In many cases, the primary liquid may be removed by a unidirectional mass transfer mechanism such as evaporation, wicking, blotting, mechanical compression or others. Some methods may use bidirectional mass transfer such as rinsing or washing. In some cases, one method may be used to remove the primary liquid and a second method may be used for the secondary liquid. For example, the primary liquid may be at least partially removed by evaporation while the remaining primary liquid and secondary liquid may be removed by rinsing or mechanically squeezing the material.

Three embodiments are presented below of formulations and methods of production for porous material.

In a first embodiment, the porous material may be formed by first forming a layer of a polymer solution on a substrate, wherein the polymer solution may comprise two miscible liquids and a polymer material dissolved therein, wherein the two miscible liquids may comprise (i) a principal solvent liquid that may have a surface tension at least 5% lower than the surface energy of the polymer and (ii) a second liquid that may have a surface tension at least 5% greater than the surface energy of the polymer. Second, a gelled polymer may be produced from the layer of polymer solution under conditions sufficient to provide a non-wetting, high surface tension solution within the layer of polymer solution; and, thirdly, rapidly removing the liquid from the film of gelled polymer by unidirectional mass transfer without dissolving the gelled polymer to produce the strong, highly porous, microporous polymer 102 and 104.

In a second embodiment, the porous material 104 may be produced using a method comprising:

(i) preparing a solution of one or more polymers in a mixture of a principal liquid which is a solvent for the polymer and a second liquid which is miscible with the principal liquid, wherein (i) the principal liquid may have a surface tension at least 5% lower than the surface energy of the polymer, (ii) the second liquid may have a surface tension at least 5% higher than the surface energy of the polymer, (iii) the normal boiling point of the principal liquid is less than 125° C. and the normal boiling point of the second liquid is less than about 160° C., (iv) the polymer may have a lower solubility in the second liquid than in the principal liquid, and (v) the solution may be prepared at a temperature less than about 20° C. above the normal boiling point of the principal liquid and while precluding any substantial evaporation of the principal liquid;

(ii) reducing the temperature of the solution by at least 5° C. to between the normal boiling point of the principal liquid and the temperature of the substrate upon the solution is to be cast;

(iii) casting the polymer solution onto a high surface energy substrate to form a liquid coating thereon, said substrate having a surface energy greater than the surface energy of the polymer; and

(iv) removing the principal liquid and the second liquid from the coating by unidirectional mass transfer without use of an extraction bath, (ii) without re-dissolving the polymer, and (iii) at a maximum air temperature of less than about 100° C. within a period of about 5 minutes, to form the strong, highly porous, thin, symmetric polymer membrane.

In a third embodiment, the porous material 104 may be produced by a method comprising:

(i) dissolving about 3 to 20% by weight of a polymer in a heated multiple liquid system comprising (a) a principal liquid which is a solvent for the polymer and (b) a second liquid to form a polymer solution, wherein (i) the principal liquid may have a surface tension at least 5% lower than the surface energy of the polymer, (ii) the second liquid may have a surface tension at least 5% greater than the surface energy of the polymer; and (iii) the polymer may have a lower solubility in the second liquid than it has in the principal solvent liquid;

(ii) reducing the temperature of the solution by at least 5° C. to between the normal boiling point of the principal liquid and the temperature of the substrate upon which it will be cast;

(iii) casting a film of the fully dissolved solution onto a substrate which may have a higher surface energy than the surface energy of the polymer;

(iv) precipitating the polymer to form a continuous gel phase while maintaining at least 70% of the total liquid content of the initial polymer solution, said precipitation caused by a means selected from the group consisting of cooling, extended dwell time, solvent evaporation, vibration, or ultrasonics; and

(v) removing the residual liquids without causing dissolution of the continuous gel phase by unidirectional mass transfer without any extraction bath, at a maximum film temperature which is less than the normal boiling point of the lowest boiling liquid, and within a period of about 5 minutes, to form a strong, highly porous, thin, symmetric polymer membrane.

The preceding embodiments are examples of different methods by which a porous material may be formed from a liquid solution to a porous polymer. Different embodiments may be used to create the porous material 102 and 104 and such embodiments may contain additional steps or fewer steps than the embodiments described above. Other embodiments may also use different processing times, concentrations of materials, or other variations.

Each of the embodiments of porous material 102 and 104 may begin with the formation of a solution of one or more soluble polymers in a liquid medium that comprises two or more dissimilar but miscible liquids. To form highly porous products, the total polymer concentration may generally be in the range of about 3 to 20% by weight. Lower polymer concentrations of about 3 to 10% may be preferred for the preparation of membranes having porosities greater than 70%, preferably greater than 75%, and most preferably greater than 80% by weight. Higher polymer concentrations of about 10 to 20% may be more useful to prepare slightly lower porosity membranes, i.e. about 60 to 70%.

A suitable temperature for forming the polymer solution may generally range from about 40° C. up to about 20° above the normal boiling point of the principal liquid, preferably about 40 to 80° C., more preferably about 50° C. to about 70° C. A suitable pressure for forming the polymer solution may generally range from about 0 to about 50 psig. In some embodiments, the polymer solution may be formed in a vacuum. Preferably a sealed pressurized system is used.

The material 102 may be formed in the presence of at least two dissimilar but miscible liquids to form the polymer solution from which a polymer film may be cast. The first “principal” liquid may be a better solvent for the polymer than the second liquid and may have a surface tension at least 5%, preferably at least 10%, lower than the surface energy of the polymer involved. The second liquid may be a solvent or a non-solvent for the polymer and may have a surface tension at least 5%, preferably at least 10%, greater than the surface energy of the polymer.

The principal liquid may be at least 70%, preferably about 80 to 95%, by weight of the total liquid medium. The principal liquid may dissolve the polymer at the temperature and pressure at which the solution may be formed. The dissolution may generally take place near or above the boiling temperature of the principal liquid, usually in a sealed container to prevent evaporation of the principal liquid. The principal liquid may have a greater solvent strength for the polymer than the second liquid. Also, the principal liquid may have a surface tension at least about 5%, preferably at least about 10%, lower than the surface energy of the polymer. The lower surface tension may lead to better polymer wetting and hence greater solubilizing power.

The second liquid, which may generally represent about 1 to 10% by weight of the total liquid medium, may be miscible with the first liquid. The second liquid may or may not dissolve the polymer as well as the first liquid at the selected temperature and pressure. The second liquid may have a higher surface tension than the surface energy of the polymer. Preferably, the second liquid may or may not wet the polymer at the gelation temperature though it may wet the polymer at more elevated temperatures.

Table A and Table B identify some specific principal and second liquids that may be used with typical polymers, especially including PVDF. Table A lists liquids that have at least some degree of solubility towards PVDF (surface energy of 35 dyne/cm), which may produce the dissolved polymer solution in the first step of the process. Ideally, a liquid may be selected from Table A that has solubility limits between 1% and 50% by weight of polymer at a temperature within the range of about 20 and 90° C. The liquids in Table B, on the other hand, may have lower polymer solubility than those in Table A, but may be selected because they have a higher surface tension than both the principal liquid and the polymers that may be dissolved in the solution made with liquid(s) from Table A.

Tables A and B represent typical examples of suitable liquids that may be used to create a porous material 102 and 104. Other embodiments may use different liquids as a principal liquid or second liquid.

Examples of suitable liquids for use as the principal liquid, along with their boiling point and surface tensions are provided in Table A below. The table is arranged in order of increasing boiling point, which is a useful parameter for achieving rapid gelling and removal of the liquid during the film formation step. In some applications, a lower boiling point may be preferred.

TABLE A

| | Normal Boiling | Surface Energy, |
|---|---|---|
| Principal Liquid | Point, EC | dynes/cm |
| methyl formate | 31.7 | 24.4 |
| acetone (2-propanone) | 56 | 23.5 |
| methyl acetate | 56.9 | 24.7 |
| Tetrahydrofuran | 66 | 26.4 |
| ethyl acetate | 77 | 23.4 |
| methyl ethyl ketone (2-butanone) | 80 | 24 |
| Acetonitrile | 81 | 29 |
| dimethyl carbonate | 90 | 31.9 |
| 1,2-dioxane | 100 | 32 |
| Toluene | 110 | 28.4 |
| methyl isobutyl ketone | 116 | 23.4 |

Examples of suitable liquids for use as the second liquid, along with their boiling point and surface tensions are provided in Table B below. This table is arranged in order of increasing surface tension as higher surface tension may result in optimum pore size distributions during the gelling and liquid removal steps of the process.

TABLE B

| | Normal boiling | Surface Energy, |
|---|---|---|
| Second Liquid | point, ° C. | dynes/cm |
| nitromethane | 101 | 37 |
| bromobenzene | 156 | 37 |
| formic acid | 100 | 38 |
| pyridine | 114 | 38 |
| ethylene bromide | 131 | 38 |
| 3-furaldehyde | 144 | 40 |
| bromine | 59 | 42 |
| tribromomethane | 150 | 42 |
| quinoline | 24 | 43 |
| nitric acid (69%) | 86 | 43 |
| water | 100 | 72.5 |

The porous material may be formed by using a liquid medium for forming the polymer solution. The liquid medium may be rapidly removable at a sufficiently low temperature so that the second liquid may be removed without re-dissolving the polymer during the liquid removal process. The liquid medium may or may not be devoid of plasticizers. The liquids that form the liquid medium may be relatively low boiling point materials. In many embodiments, the liquids may boil at temperatures less than about 125° C., preferably about 100° C. and below. Somewhat higher boiling point liquids, i.e. up to about 160° C., may be used as the second liquid if at least about 60% of the total liquid medium is removable at low temperature, e.g. less than about 50° C. The balance of the liquid medium can be removed at a higher temperature and/or under reduced pressure. Suitable removal conditions depend upon the specific liquids, polymers, and concentrations utilized.

Preferably the liquid removal may be completed within a short period of time, e.g. less than 5 minutes, preferably within about 2 minutes, and most preferably within about 1.5 minutes. Rapid low temperature liquid removal, preferably using air flowing at a temperature of about 80° C. and below, most preferably at about 60° C. and below, without immersion of the membrane into another liquid has been found to produce a membrane with enhanced uniformity. The liquid removal may be done in a tunnel oven with an opportunity to remove and/or recover flammable, toxic or expensive liquids. The tunnel oven temperature may be operated at a temperature less than about 90° C., preferably less than about 60° C.

The polymer solution may become supersaturated in the process of film formation. Generally cooling of the solution will cause the supersaturation. Alternatively, the solution may become supersaturated after film formation by means of evaporation of a portion of the principal liquid. In each of these cases, a polymer gel may be formed while there is still sufficient liquid present to generate the desired high void content in the resulting polymer film when that remaining liquid is subsequently removed.

After the polymer solution has been prepared, it may then be formed into a thin film. The film-forming temperature may be preferably lower than the solution-forming temperature. The film-forming temperature may be sufficiently low that a polymer gel may rapidly form. That gel may then be stable throughout the liquid removal procedure. A lower film-forming temperature may be accomplished, for example, by pre-cooling the substrate onto which the solution is deposited, or by self-cooling of the polymer solution by controlled evaporation of a small amount of the principal liquid.

The film-forming step may occur at a lower temperature (and often at a lower pressure) than the solution-forming step. Commonly, it may occur at or about room temperature. However, it may occur at any temperature and pressure if the gelation of the polymer is caused by means other than cooling, such as by slight drying, extended dwell time, vibrations, or the like. Application as a thin film may allow the polymer to gel in a geometry defined by the interaction of the liquids of the solution.

The thin film may be formed by any suitable means. Extrusion or flow through a controlled orifice or by flow through a doctor blade may be commonly used. The substrate onto which the solution may be deposited may have a surface energy higher than the surface energy of the polymer. Examples of suitable substrate materials (with their surface energies) include copper (44 dynes/cm), aluminum (45 dynes/cm), glass (47 dynes/cm), polyethylene terephthalate (44.7 dynes/cm), and nylon (46 dynes/cm). In some cases a metal, metalized, or glass surface may be used. More preferably the metalized surface is an aluminized polyalkylene such as aluminized polyethylene and aluminized polypropylene.

In view of the thinness of the films, the temperature throughout may be relatively uniform, though the outer surface may be slightly cooler than the bottom layer. Thermal uniformity may enable the subsequent polymer precipitation to occur in a more uniform manner.

The films may be cooled or dried in a manner that prevents coiling of the polymer chains. Thus the cooling/drying may be conducted rapidly, i.e. within about 5 minutes, preferably within about 3 minutes, most preferably within about 2 minutes, because a rapid solidification of the spread polymer solution facilitates retention of the partially uncoiled orientation of the polymer molecules when first deposited from the polymer solution.

The process may entail producing a film of gelled polymer from the layer of polymer solution under conditions sufficient to provide a non-wetting, high surface tension solution within the layer of polymer solution. Preferably gelation of the polymer into a continuous gel phase occurs while maintaining at least 70% of the total liquid content of the initial polymer solution. More particularly, the precipitation of the gelled polymer is caused by a means selected from a group consisting of cooling, extended dwell time, solvent evaporation, vibration, or ultrasonics. Then, the balance of the liquids may be removed by a unidirectional process, usually by evaporation, from the formed film to form a strong micro-porous membrane of geometry controlled by the combination of the two liquids in the medium. In some embodiments, a liquid bath may be used to extract the liquids from the membrane. In other embodiments, the liquid materials may evaporate at moderate temperatures, i.e. at a temperature lower than that used for the polymer dissolution to prepare the polymer solution. The reduced temperature may be accomplished by the use of cool air or even the use of forced convection with cool to slightly warmed air to promote greater evaporative cooling.

The interaction among the two liquids (with their different surface tension characteristics) and the polymer (with a surface energy intermediate the surface tensions of the liquids) may yield a membrane with high porosity and relatively uniform pore size throughout its thickness. The surface tension forces may act at the interface between the liquids and the polymer to give uniformity to the cell structure during the removal step. The resulting product may be a solid polymeric membrane with relatively high porosity and uniformity of pore size. The strength of the membrane in some embodiments may be surprisingly high, due to the more linear orientation of polymer molecules.

The ratio of the principal liquid to the second liquid at the point of gelation may be adjusted such that the surface tension of the composite liquid phase may be greater than the surface energy of the polymer. The calculation of the composite liquid surface tension can be predicted based upon the mol fractions of liquids, as defined in “Surface Tension Prediction for Liquid Mixtures,” AIChE Journal, vol 44, no. 10, p. 2324, 1998, the subject matter of which is incorporated herein by reference.

Reid, Prausnitz, and Sherwood “The Properties of Gasses and Liquids”, 3d Ed, McGraw Hill Book Company p. 621.

Thermodynamic calculations show that adiabatic cooling of a solution can be significant initially and that the temperature gradient through such a film is very small. The latter may be considered responsible for the exceptional uniformity obtained using these methods.

The polymers used to produce the microporous membranes of the present invention may be organic polymers. Accordingly, the microporous polymers comprise carbon and a chemical group selected from hydrogen, halogen, oxygen, nitrogen, sulfur and a combination thereof. In a preferred embodiment, the composition of the microporous polymer may include a halogen. Preferably, the halogen is selected from the group consisting of chloride, fluoride, and a mixture thereof.

Suitable polymers for use herein may be include semi-crystalline or a blend of at least one amorphous polymer and at least one crystalline polymer.

Preferred semi-crystalline polymers may be selected from the group consisting of polyvinylidene fluoride, polyvinylidene fluoride-hexafluoropropylene copolymer, polyvinyl chloride, polyvinylidene chloride, chlorinated polyvinyl chloride, polymethyl methacrylate, and mixtures of two or more of these semi-crystalline polymers.

In some embodiments, the products produced by the processes described herein may be used as a battery separator. For this use, the polymer may comprise a polymer selected from the group consisting of polyvinylidene fluoride (PVDF), polylvinylidene fluoride-hexafluoropropylene copolymer (PVDF-HFP), polyvinyl chloride, and mixtures thereof. Still more preferably the polymer may comprise at least about 75% polyvinylidene fluoride.

The “MacMullin” or “McMullin” Number measures resistance to ion flow is defined in U.S. Pat. No. 4,464,238, the subject matter of which is incorporated herein by reference. The MacMullin Number is “a measure of resistance to movement of ions. The product of MacMullin Number and thickness defines an equivalent path length for ionic transport through the separator. The MacMullin Number appears explicitly in the one-dimensional dilute solution flux equations which govern the movement of ionic species within the separator; it is of practical utility because of the ease with which it is determined experimentally.” The lower a MacMullin Number the better for battery separators, the better. Products using these techniques may have a low MacMullin number, i.e. about 1.05 to 3, preferably about 1.05 to less than 2, most preferably about 1.05 to about 1.8.

Good tortuosity is an additional attribute of some embodiments. A devious or tortuous flow path with multiple interruptions and fine pores may act as a filter against penetration of invading solids. Tortuosity of the flow path can be helpful to prevent penetration by loose particles from an electrode or to minimize growth of dendrites through a separator that might cause electrical shorts. This characteristic cannot be quantified, except by long-term use, but it can be observed qualitatively by viewing a cross-section of the porosity.

Some embodiments may be generally uniform and symmetric, i.e. the substrate side pores may be substantially similar in size to the central and the air side pores. Pores varying in diameter by a factor of about 5 or less may be sufficiently uniform for the membranes to function in a symmetric manner.

Where additional strength or stiffness may be needed for handling purposes, micro- or nano-particles can be added to the formulation with such particulates residing within the polymer phase. A few such additives include silica aerogel, talc, and clay.

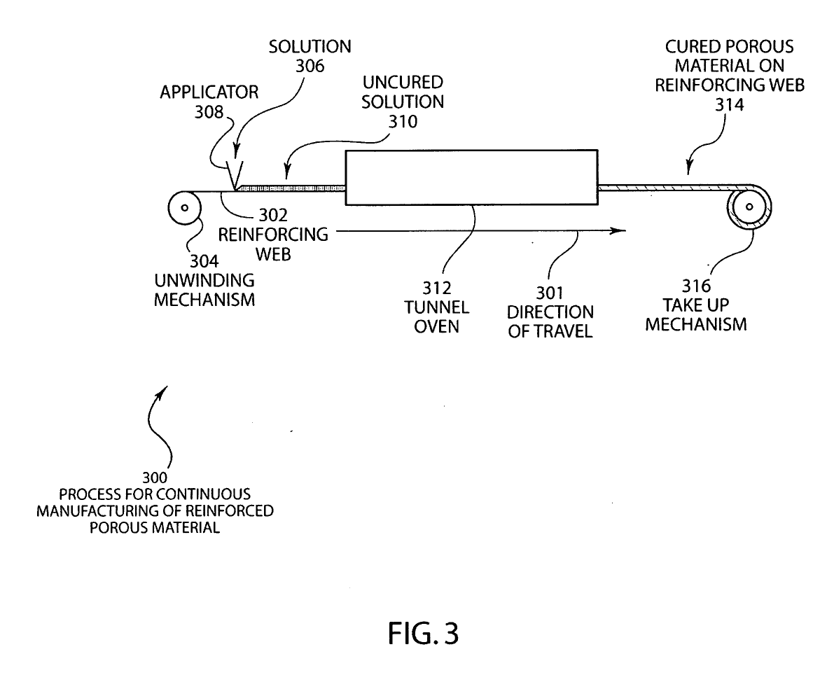

FIG. 3 is a diagram illustration of an embodiment 300 showing a process for continuous manufacturing of reinforced porous material. Embodiment 300 is an example of a general process that may be used to form porous material directly in a reinforced web, such as a nonwoven web, woven web, or perforated film.

A web 302 may be unwound with an unwinding mechanism 304 and moved in the direction of travel 301. Various reinforcement webs may be used, including woven and nonwoven. In many embodiments, a nonwoven web may be preferred from a cost standpoint.

As the web 302 is being moved in the direction 301, solution 302 may be applied to the web 302 with an applicator 308. The applicator 308 may apply a wet solution 306 to form an uncured solution 310.

In some embodiments, a carrier material may be used to facilitate handling of the web and may provide a bottom surface against which the liquid solution 306 may be supported while in the uncured state. Such carrier material may include treated kraft paper, various polymeric films, metal films, metalized carriers, or other material. Some embodiments may use a carrier material in subsequent manufacturing steps and may include the carrier material with the cured porous material 314 on the take up mechanism 316. In other embodiments, the carrier material may be stripped from the cured porous material 314 before the take up mechanism 316. In still other embodiments, a continuous recirculating belt or screen may be used beneath the web 302 during processing.

The embodiment 300 illustrates a manufacturing sequence that may be predominantly horizontal. In other embodiments, a vertical manufacturing process may have a direction of travel in either vertical direction, either up or down. A vertical direction of travel may enable a porous material to evenly form on two sides of a reinforcement web. Such an embodiment may have an applicator system that may apply solution to both sides of a reinforcement web. Horizontal manufacturing processes, such as embodiment 300, may result in a final product that may be asymmetrical, with the reinforcement web being located off the centerline of the thickness of the material.

The applicator 308 may be any mechanism by which the solution 306 may be applied to the web 302. In some embodiments, the solution 306 may be continuously cast, sprayed, extruded, or otherwise applied. Some embodiments may use a doctor blade or other mechanism to distribute the solution 306.

The thickness of the resulting reinforced porous material may be adjusted by controlling the amount of solution 306 that is applied to the web 302 and the speed of the web during application, among other variables.

Some embodiments may includes various additional processes, such as air knives, calendering, rolling, or other processing before, during, or after the solution 306 has formed into a solid porous polymer material.

The uncured solution 310 may be transferred through a tunnel oven 312 or other processes in order to form a cured porous material 314, which may be taken up with a take up mechanism 316.

The tunnel oven 312 may have different zones for applying various temperature profiles to the uncured solution 310 in order to form a porous material. In many cases, an initial lower temperature may be used to evaporate a portion of a primary liquid and begin formation of a solid polymer structure. A higher temperature may be used to remove a second liquid and remaining primary liquid.

In some embodiments, the tunnel oven 312 may provide air transfer using heated or cooled air to facilitate curing.

Embodiment 300 is an example of a continuous process for manufacturing a reinforced porous material by forming the porous material by introducing a wet solution directly onto the reinforcement media. Other embodiments may include casting a porous material directly onto a reinforced web in a batch mode, such as casting on non-moving table surface.

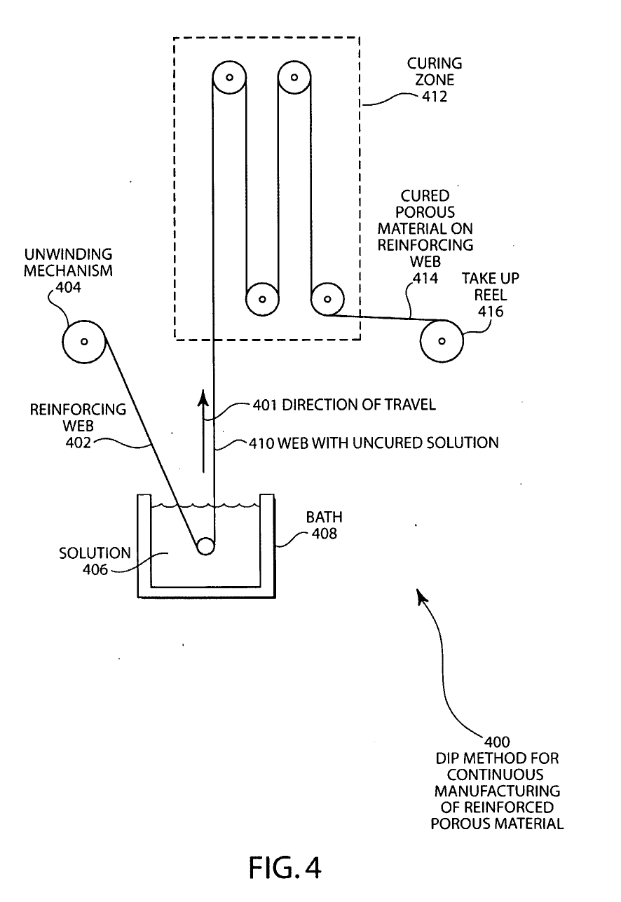

FIG. 4 is a diagram illustration of an embodiment 400 showing a dip method for continuous manufacturing of reinforced porous material.

A web 402 is unwound from an unwinding mechanism 404 and passed through a solution 406 in a bath 408 to form a web with uncured solution 410. The bath 408 may be ultrasonically activated to remove air and promote wetting of the reinforcement by the solution. The web may pass through a curing zone 412 in which may remove a primary and secondary liquid while forming a polymer with a porous structure. The cured material on a web 414 may be taken up in a take up reel 416.

Embodiment 400 is an example of a continuous process for forming a porous material directly onto a reinforcement web. By controlling the viscosity of the solution 406 and the speed of operation, a controlled thickness of porous material may be formed. In some embodiments, a doctor blade, calendering mechanism, air knives, or other mechanisms may be used to provide additional control over the thickness of the uncured or cured material.

The curing zone 412 may be any type of mechanism by which the uncured material 410 may be cured. Some embodiments may process the material through various heated or cooled zones, apply various rinses, process the material through a pressurized or vacuum environment, or provide some mechanical processing such as calendering, squeezing, or some other process. Each embodiment may have particular processing performed based on the selection of polymer, the formulation of the solution 406, and the construction of the reinforcing web 402.

In some embodiments, the reinforcing web 402 may have various treatments applied prior to coming in contact with the solution 406. For example, a sizing or other liquid material may be applied to the web 402. One example may be to pretreat the web 402 with a dilute version of the solution 406 or a solution with a different solvent/polymer combination. In some cases, such a pretreatment may cause the reinforcing web 402 to swell or otherwise improve the bonding of the porous material to the web 402. Other examples may include applying a corona or spray to the web 402 to partially oxidize the surface of the web 402. Another example may be to apply an electric charge to the web 402 and an opposite charge to the bath 408. Still another example may be to ionize the surface of the reinforcing web 402. Such pretreatment processes may be used with any method for manufacturing a reinforced porous film.

Ultrasonic activation of the solution 406 and reinforcing web 402 may enhance bonding and penetration of the solution 406 into the web.

Ultrasonic activation may be used to supplement any type of mechanism by which a pore forming polymer solution may be applied to a reinforcing web. In some embodiments, ultrasonic energy may be introduced to the solution, while in other embodiments, ultrasonic energy may be applied to the reinforcing web before or after the solution is applied. In embodiment 400, ultrasonic energy may be applied to the bath 408 or to the reinforcing web 402 prior to entering the bath 408. Some embodiments may introduce ultrasonic energy to the web after the solution is applied by using an ultrasonic horn directed toward the web.

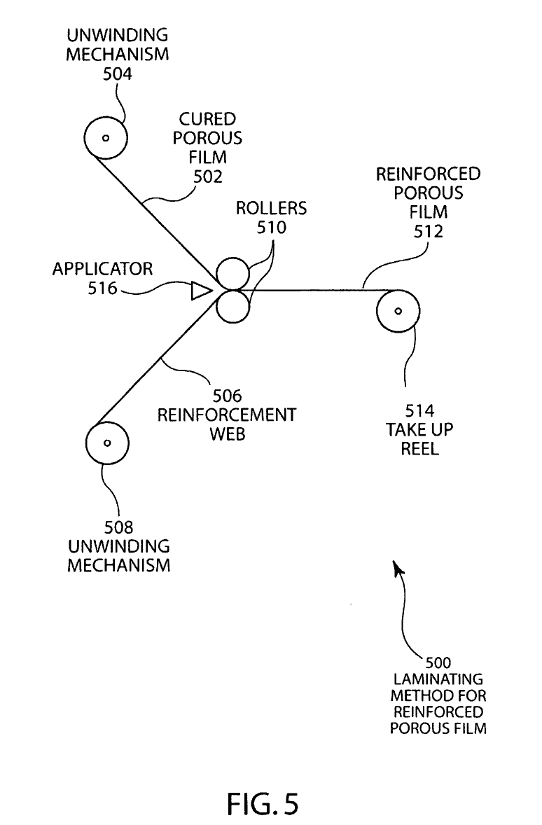

FIG. 5 is a diagram illustration of an embodiment 500 showing a method for laminating reinforced porous film. Embodiment 500 shows a single cured porous film 502 being joined to one side of a reinforced web 506.

The porous film 502 may be unwound from an unwinding mechanism 504 and brought into contact with a reinforcement web 506 that is unwound from a second unwinding mechanism 508. The two plies may be joined by the rollers 510 to form a reinforced porous film 512 that may be wound onto a take up reel 514.

Embodiment 500 is a method and apparatus for laminating a porous film 504 with a reinforcement web 506. In some embodiments, an applicator 516 may be used to deliver ionic charge, adhesive, heat, or any other material or processing at the nip point of the joining process.

An adhesive may be used to join the two layers. In some embodiments, the adhesive may contain a solvent that may enable a portion of either or both the polymer from the porous material or the reinforcement web to melt or dissolve and fuse with the other layer. In some cases, a polymer mixture may be used in forming the porous material with one of the polymers in the mixture selected to dissolve in an adhesive to facilitate the bonding to the reinforcement web. Another type of adhesive may contain a dissolved polymer that gels between the two layers to join the layers together. Another adhesive may be heat activated and may partially melt to join the layers.

When adhesives are used, some embodiments may apply a coating of adhesive across one or both of the surfaces to be joined. Other embodiments may apply spots of adhesive in various locations or patterns.

The applicator 516 may apply heat to one or more surfaces to be joined. In some embodiments, the heat may enable a portion of one or more of the materials to be joined to melt and fuse with the other. Such heat may be applied in conjunction with an adhesive.

In some embodiments, the porous film 502 and reinforcement web 506 may be joined together by mechanical interlocking. Such interlocking may be created by applying pressure between the rollers 510.

In some cases, the porous film 502 may be transferred through a portion of the manufacturing process using a carrier film or other material. In such a case, the carrier film may be removed prior to entering the rollers 510.

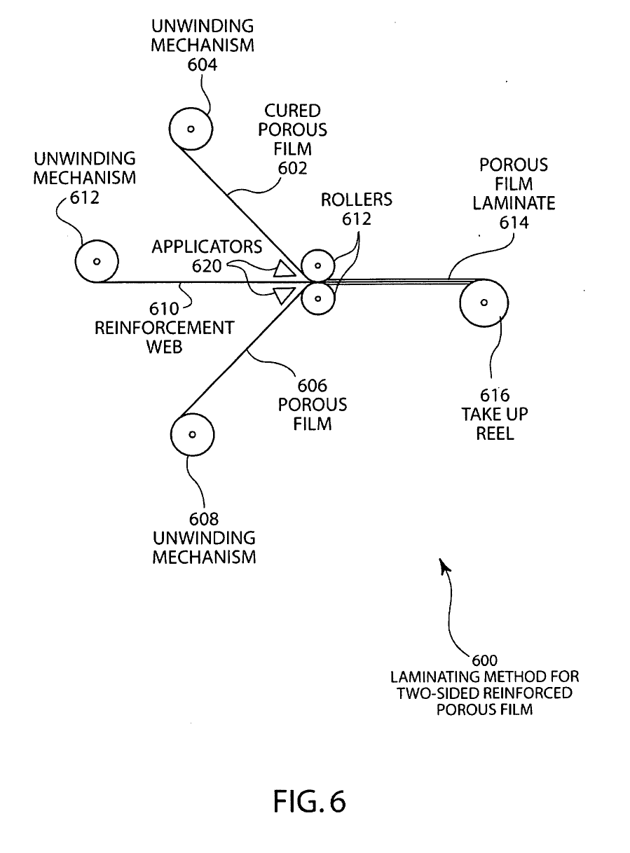

FIG. 6 is a diagram illustration of an embodiment 600 showing a laminating method for two-sided lamination of porous film onto a central reinforced web. Embodiment 600 may use similar processing to that of embodiment 500, with the addition of a second layer of porous film added so that the reinforcing web is in the center of the laminate.

A first porous film 602 may be unwound from an unwinding mechanism 604, and similarly a second porous film 606 may be unwound from unwinding mechanism 608. A reinforcement web 610 is unwound from an unwinding mechanism 612 and laminated between the porous film layers 602 and 606 at the rollers 612 to form a laminate 614 that is taken up by a take up reel 616.

Embodiment 600 may join the layers of porous film and a reinforcement web by any mechanism whatsoever. In some cases, mechanical interlocking may be used, while in other cases, applicators 620 may apply heat and/or adhesives or other bonding agent or processing that may facilitate bonding.

An adhesive may be used to join the various layers. In some embodiments, the adhesive may contain a solvent that may enable a portion of either or both the polymer from the porous material or the reinforcement web to melt or dissolve and fuse with the other layer. In some cases, a polymer mixture may be used in forming the porous material with one of the polymers in the mixture selected to dissolve in an adhesive to facilitate the bonding to the reinforcement web. Another type of adhesive may contain a dissolved polymer that gels between the two layers to join the layers together. Another adhesive may be heat activated and may partially melt to join the layers.

When adhesives are used, some embodiments may apply a coating of adhesive across one or both of the surfaces to be joined. Other embodiments may apply spots of adhesive in various locations or patterns.

The applicator 620 may apply heat to one or more surfaces to be joined. In some embodiments, the heat may enable a portion of one or more of the materials to be joined to melt and fuse with the other. Such heat may be applied in conjunction with an adhesive.

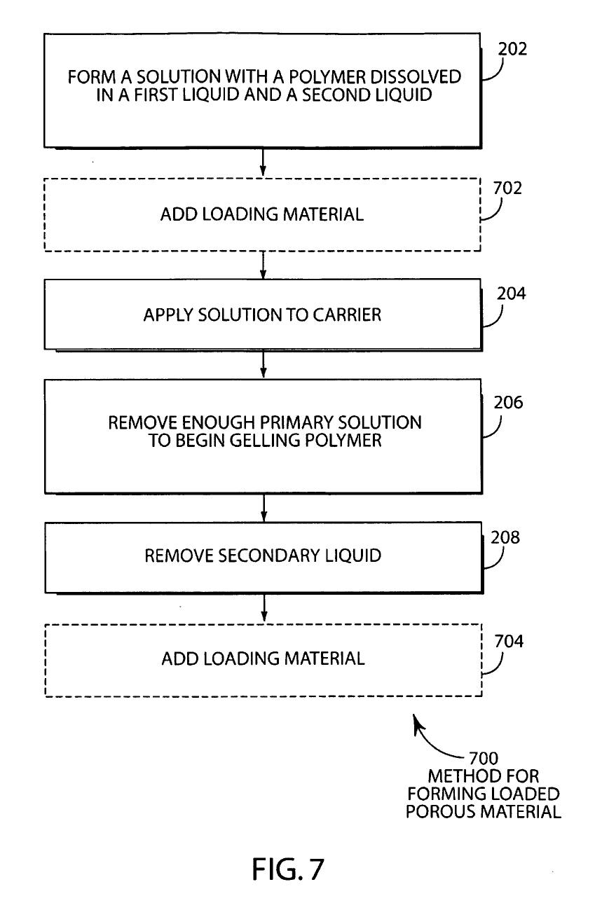

FIG. 7 is a flowchart illustration of an embodiment 700 showing a method for creating a loaded porous material. The loading may be any nonstructural material that may perform various functions.

In some cases, a loading may be passive and perform a function without changing state or engaging in a chemical reaction. In other cases, an active loading may undergo a chemical reaction or otherwise change state.

Loading may be applied using two different application mechanisms. In one mechanism, a loading may be incorporated into the porous material solution and may become bound into the structure of the porous material. In another mechanism, a loading may be applied to the porous material after formation and may be captured within the pores of the porous material.

In some embodiments, a two part loading material may be used. In such an embodiment, a first material may be incorporated into the solution and may be captured within the porous structure. A second part of the loading material may be applied to the formed porous material and the second part may interact with the first part to create the loading. In some cases, the second part may react with the first part or otherwise cause the first part to undergo a chemical transformation.

The illustration of FIG. 7 is a similar process as FIG. 2, with the addition of loading material prior to and/or after porous material formation.

The solution is formed in block 202 as described above.

Loading material may be added to the solution in block 702. The loading material may be dissolved in the solution of block 202 or may be a particulate that may be suspended in the solution.

The solution may be applied to a carrier in block 204, and enough of the primary solution may be removed in block 206 to begin gelation. The secondary liquid may be removed in block 208.

Loading material may be added in block 704 which may be after the porous material is formed. In such a case, the loading material may be infused within the porous structure in several manners. In some cases, the loading material may be dissolved in a solution which may permeate the porous material. The solution may be dried, leaving a residue of loading material.

In some cases, a particulate loading material may be infused into the porous structure as a dry material or with a liquid carrier.

In some embodiments, other mechanisms for depositing a loading material may include vacuum deposition mechanisms, surface treatments, or other mechanisms. In some embodiments, the loading material may be applied through the porous structure, while in other cases, the loading material may be applied to the outer surface of the porous structure.

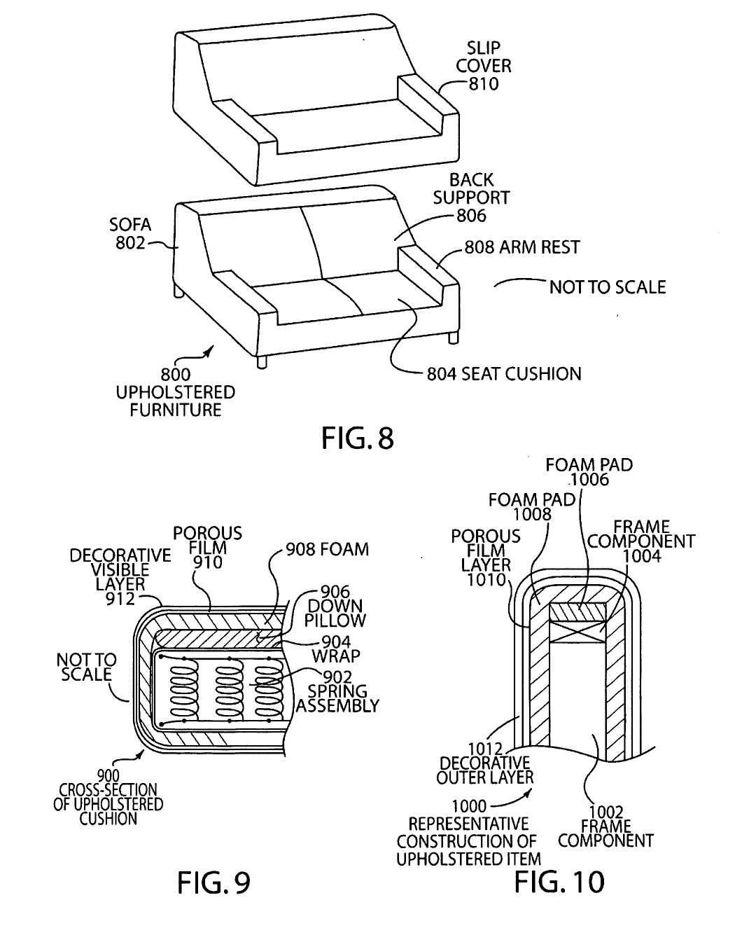

FIG. 8 is a diagram illustration of an embodiment 800 showing an upholstered furniture item that may have a porous film layer as part of the construction of the furniture item, especially in the seating area. FIG. 8 is not to scale.

Embodiment 800 is a simplified illustration of a sofa or love seat. Other embodiments may be any type of furniture that may have upholstered elements, such as chairs, stools, benches, sofas, sectional sofas, couches, footstools, ottomans, recliners, settees, and other seating furniture that may be designed for use indoors and outdoors. In other embodiments, upholstered elements may be present in chests, headboards, or other non-seating types of furniture.

Embodiment 800 shows a sofa 802 that has a seat cushion 804, a back support 806, and an armrest 808. The seating area of the sofa 802 may be made up of the seat cushion 804, the back support 806 and the armrest 808. In many embodiments, the seating area may have a layer of a microporous material incorporated into the construction of the furniture item. In some embodiments, other portions of an upholstered furniture item may include a layer of microporous material in addition to or exclusive of a seating area.

Some embodiments may include slip covers 810 or other covers that may be placed over an upholstered item. A slip cover 810 or other cover may be manufactured from a microporous film.

Embodiment 800 may be created with a support structure or frame. In many cases, upholstered items such as chairs or sofas may be constructed with a metal or wooden frame. Upholstery may be constructed on the frame and attached to the frame for areas such as an armrest or other cushion. In some designs, some elements such as a seat cushion or back support may be separable cushions that are placed on the furniture item but may not be attached.

The sofa 802 is an example of an upholstered item. Other embodiments may include upholstered items in vehicles. For example, an automobile may have various upholstered interior pieces such as dashboards, headliners, door panels, wall panels, as well as seating areas. An airplane may also have upholstered interior panels as well as upholstered seats. A boat may have upholstered interior and exterior items.

A microporous layer may be incorporated into an upholstered item in several different manners. In many embodiments, an upholstered item may have an external visible material and an internal microporous layer. The external visible material may be a sheet material, such as woven or nonwoven textile fabric, leather, simulated leather, or other similar material.

In many cases, the internal microporous layer may be directly in contact with the outer or external material, while in other cases, an intermediate layer may be placed between the external material and the microporous layer.

An intermediate layer may be used in cases where the microporous layer is noisy when manipulated. By placing the an intermediate layer between the outer layer and the microporous layer, the amount of manipulation experienced by the microporous layer may be minimized and any sound created by the microporous layer may be better absorbed. In many embodiments, an intermediate layer may consist of batting or other layer that may have a cushioning effect. In some embodiments, the intermediate layer may be a sheet type material that may permit the outer layer to slide or shift with respect to the microporous layer.

In some embodiments, the microporous layer may be incorporated into the outer layer. In some cases, the microporous layer may be laminated to the outer layer.

An outer layer may be laminated to a microporous layer using several different methods. In some cases, the microporous layer may be formed directly onto the outer layer.

In some embodiments, the microporous layer may be heat laminated or bonded to an external layer. In cases where heat laminating or adhesive bonding is used, the lamination process may be performed on the entire surface between the microporous layer and the external layer. In some embodiments with heat laminating, the lamination may be performed in a discontinuous pattern, such as spots of lamination that are spaced apart. In such embodiments, two layers may be joined together and may have a majority of the surface area between the layers free from lamination. For example, some embodiments may have a laminated area that is 10%, 1% or even less than the total surface area of the laminate.

Some embodiments may have a microporous layer formed directly onto the outer layer, where the outer layer may be a reinforcement member for the microporous material as described above. In some such embodiments, the polymer solution used to make the microporous material may be applied to the external material such that the solution fully or partially wets the external material. When the solution fully wets through the thickness of the external material, the outer exposed surface of the external material may be changed from the unprocessed state. When the solution does not wet through the thickness of the external material, the microporous material may be formed in the internal side of the material and the external or visible surface may not be changed from the unprocessed state.

In some embodiments, upholstered products may be manufactured with two or three layers being sewn together with no lamination. Such products may have one of the layers as a microporous layer that may or may not be constructed with a reinforcement web.

The microporous material described above may be used in a furniture item to provide different features in various applications.

In many embodiments, the microporous material described above may be air permeable but may also sustain at least a small hydrostatic head. As such, the microporous material may repel water yet may also be breathable. Airflow through an upholstered item may, in many cases, give the item a more comfortable feel, especially when a person's skin is in direct contact. In some embodiments, a breathable covering may allow an upholstered item to compress and decrease in volume, such as when a person sits on a seating cushion.

The hydrostatic head may prevent spilled liquids, incontinence, or other events from causing liquids to infiltrate below the microporous material and being absorbed into padding or other material internal to the upholstery.

In some embodiments, a microporous material may be incorporated into the construction of an upholstered item by placing the microporous material below an exterior or visible material. In such a position, a liquid may penetrate the exterior material, but may be prevented from infiltrating further into the upholstery by the microporous membrane. A spill on an upholstered item of such construction may wet the exterior fabric or other material which may be wiped or dabbed clean.

In such embodiments, the microporous material may be incorporated as a separate, unattached layer within an upholstered construction. In some embodiments, the microporous membrane may be laminated to the exterior material of the upholstered item.

Some embodiments may have the microporous material formed in situ using the exterior material as a reinforcement. In a typical version of such an embodiment, the microporous material may be sprayed, screed, or poured onto one surface of the exterior material. Some versions of such a manufacturing process may allow the microporous material to be formed on one side of the exterior material without wetting through the material and leaving one side of the exterior material with a natural state. Other versions of the manufacturing process may wet through the material and may change the look and feel of the external material.

Another use scenario may be to act as a dust mite barrier or a barrier to other insects, pests, or pathogens.

The microporous film may serve as an effective dust mite barrier as a physical barrier through which a dust mite or dust mite feces may not pass. An average dust mite may have a size of 0.42 mm and may leave fecal matter that may be 0.02 mm in size. The microporous film may be manufactured to have pores in the range of 0.01 mm or smaller. Some embodiments may have average pore size as small as 0.005 mm or smaller.

In many embodiments, a microporous film may have high tortuosity that may inhibit or prevent dust mites or dust mite fecal matter from traversing the film and coming into contact with a person.

Another use scenario may be to prohibit mold, fungus, bacteria, or other microbes by adding additive materials to the microporous material.

In some embodiments, the microporous film may be infiltrated or coated with various anti-microbial agents that may inhibit mold, mildew, bacteria, or other unwanted organisms. In some embodiments, the microporous film may be infiltrated or coated with an insecticide or other agent that may kill or deter insects or other pests such as dust mites. Such materials may be added to the porous film by dipping or spraying the film after manufacturing the film. In some embodiments, the materials may be added to the porous film by incorporating the materials in the solution prior to forming the porous film.

In embodiments with anti-pathogen properties such as anti-microbial properties described above, additives such as iodine, silver, silver oxide, silver nitrate, zinc, zinc sterate, copper glutamate, copper chloride, or other materials may be added to the microporous film. Such materials may be added to the polymer solution prior to forming the microporous film or by applying the materials after formation. Another material that may be added during formation may be an ultraviolet barrier may be created by adding zinc oxide to the microporous film.

Another use scenario may be to add scents to the microporous material. The scents may be transmitted into the air when an upholstered item is compressed, such as when a person sits on an upholstered seat cushion.

FIG. 9 is a diagram illustration of an embodiment 900 showing a cross section of an upholstered cushion that may have a microporous film or material. Embodiment 900 is an example of a specific type of cushion, however a microporous material may be incorporated into the cushion in several different manners, and may be applied to many different types of upholstered cushions or materials. FIG. 9 is not to scale.

FIG. 9 illustrates a common type of seat cushion that has a metal spring assembly 902 as a central core. Other types of seat cushions may have foam cores or other bulk material. The spring assembly 902 may be wrapped in a wrap 904 that may be burlap or some other heavyweight material that may keep any sharp edges from the spring assembly 902 from penetrating into the outer layers of the upholstery.

In some seat cushion, a down pillow 906 may be used above the spring assembly 902. In many cases, the down pillow 906 may provide a soft, luxurious feel to the seat cushion. Some embodiments may not have a down pillow 906. Other embodiments may use some other type of bulk material, such as a foam pad, bulk cotton, or other stuffing material.

The down pillow 906 and spring assembly 902 may be wrapped in a foam layer 908, then a porous film layer 910 and a decorative outer layer 912.

The porous film layer 910 may provide a barrier between the outer layer 912 and the inner portions of the embodiment 900. When the porous film layer 910 can support a hydrostatic head, for example, water or other liquid that may be spilled onto the seat cushion may be prevented from being absorbed by the foam layer 908 or the down pillow 906.

FIG. 10 is a diagram illustration of an embodiment 1000 showing a cross section of an upholstered item. Embodiment 1000 is an example of an upholstered item such as an upholstered armrest in a chair or sofa. FIG. 10 is not to scale.

Embodiment 1000 is a typical example of an upholstered item. Two frame components 1002 and 1004 may serve as underlying structure to the item. Common frame materials may be wood or metal.

On top of the item, a foam pad 1006 may be placed next to the frame component 1004. A second foam pad 1008 may be wrapped over the foam pad 1006 and frame components.

In many embodiments, several different types of foam or other padding may be placed in an upholstered item. Often, a more rigid foam may be placed on top of armrests or other components that may be compressed. Sometimes, a lighter weight foam may be used in areas were little if any compression may be experienced, such as the sides or back of a chair or sofa.

The foam 1006 and 1008 may be any type of foam, batting, or other filler material. In many cases, the filler material may be a soft, compilable material while in other cases, the filler material may be quite rigid.

The outer layers of the embodiment 1000 may have a porous film layer 1010 and a decorative outer layer 1012.

The porous film layer 1010 may serve as a barrier to water and may protect the foam pad 1008 from being able to absorb and collect water, which may lead to mold or other unwanted organisms. In some instances, the porous film layer 1010 may serve as a barrier to dust mites or other insects.

The porous film layer 1010 may have various additives that may be coated onto the porous film layer 1010 or may be added during the formation of the porous film layer 1010. Such additives may include scents or other olfactory conditioners, which may include activated charcoal. Other additives may be antifungal material, antibacterial material, or other additives. The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. An article of furniture comprising:
an upholstered element comprising:
a first material being an outer layer, said outer layer being a sheet material;
a second material being a microporous film manufactured from a method comprising:
forming a solution with a dissolved polymer in a first liquid and a second liquid;
applying said solution to a carrier;
removing enough of said first liquid to begin gelling said polymer;
after said gelling has begun, removing said second liquid.

2. The article of furniture of claim 1, said upholstered element being a component of a seating area.

3. The article of furniture of claim 1, said carrier being said first material.

4. The article of furniture of claim 3, said solution wetting through a full thickness of said first material.

5. The article of furniture of claim 3, said solution not wetting through a full thickness of said first material.

6. The article of furniture of claim 1, said second material being at least partially laminated to said first material.

7. The article of furniture of claim 6, said first material and said second material being laminated together at less than 10% of an interface surface area between said first material and said second material.

8. The article of furniture of claim 1, said polymer being a homopolymer of PVDF.

9. The article of furniture of claim 1, said polymer being a copolymer of PVDF and hexofloropropolyne.

10. The article of furniture of claim 1, said microporous film comprising an additive.

11. The article of furniture of claim 10, said additive being a scented additive.

12. A method of manufacturing an article of furniture comprising:
providing a frame;
upholstering at least a portion of said frame using an outer layer and a microporous film, said microporous film being manufactured from a method comprising:
forming a solution with a dissolved polymer in a first liquid and a second liquid;
applying said solution to a carrier;
removing enough of said first liquid to begin gelling said polymer;
after said gelling has begun, removing said second liquid.

13. The method of claim 12, said upholstering comprising applying a filler material.

14. The method of claim 13, said filler material being applied underneath said microporous film and said outer layer.

15. The method of claim 12 further comprising:
adding an additive to said microporous film.

16. The method of claim 15, said additive being applied to said microporous film after said gelling.

17. The method of claim 15, said additive being added to said solution prior to said gelling.

18. The method of claim 15, said additive being an olfactory additive.
